(19) United States
(12) Patent Application Publication
(10) Pub. No.: US 2006/0254055 A1
(43) Pub. Date: Nov. 16, 2006

(54) Dynamic gear train analysis

(76) Inventor: Gregory Alan Sabourin, Spring Arbor, MI (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/405,744

(22) Filed: Apr. 18, 2006

Related U.S. Application Data
(60) Provisional application No. 60/672,273, filed on Apr. 18, 2005.

(51) Int. Cl. B23P 15/14

(52) U.S. Cl. 29/893.1

(57) ABSTRACT

A method of analyzing characteristics of a gear train comprises rotating a gear train in a first direction, creating a first gear synchronization map of the gear train rotating in the first direction, rotating the gear train in a second direction opposite the first direction, creating a second gear synchronization map of the gear train rotating in the second direction, and controlling torque load of the gear train during rotation thereof in the first and second directions comparing the first gear synchronization map with the second gear synchronization map to determine relevant characteristics of the gear train.

### CROSS-REFERENCE TO RELATED APPLICATIONS

This application claims priority from U.S. Provisional Patent Application No. 60/672,273 filed on Apr. 18, 2005, which is hereby incorporated by reference.

### FIELD OF THE INVENTION

The present invention relates to method of analyzing a gear train, and more particularly, to a method to dynamically analyze a gear train to determine backlash present in the gears of the gear train.

### BACKGROUND

An important characteristic of the function of gears is the backlash of the interacting gears. The interface of the gears requires clearance. This clearance provides for thermal expansion of the gears, lubrication movement, and manufacturing tolerances of the gears. It is referred to as backlash.

Backlash is commonly understood to be the clearance between the non-driven surfaces of interacting gears across a line that intersects the contact points between the gear teeth. If one gear is constrained and it and its mating gear are moved in opposite directions, backlash will be indicated. The indication will usually be described as a straight linear dimension or as a limitation in rotation expressed in degrees of rotation.

Because the contact point, or line, slides across the surfaces of the gear teeth during the driving process there is an infinite number of positions from which you could calculate the backlash. Typically one position or tooth is randomly chosen and the backlash is measured using a fixed gauging method. However, this method does not check the full spectrum of contact points or lines on one tooth, let alone the entire gear or the combinations of gears.

This condition is compounded by the fact that almost all gearing is arranged in ratios, which means that smaller gears are paired with larger ones to produce the drive characteristics required of the drivetrain. These ratios require several revolutions to cycle the gears back to the same starting contact point.

### SUMMARY

The present invention is a method of analyzing characteristics of a gear train. The method comprises rotating a gear train in a first direction, creating a first gear synchronization map of the gear train rotating in the first direction, rotating the gear train in a second direction opposite the first direction, creating a second gear synchronization map of the gear train rotating in the second direction, and controlling torque load of the gear train during rotation thereof in the first and second directions comparing the first gear synchronization map with the second gear synchronization map to determine relevant characteristics of the gear train.

In an alternative embodiment, a method of analyzing backlash of a gear train comprises rotating a gear train in a first direction, controlling torque load of the gear train during rotation thereof in the first direction, mapping rotational synchronization of the gear train rotating in the first direction, creating a first gear synchronization map of the gear train rotating in the first direction, rotating the gear train in a second direction opposite the first direction, controlling torque load of the gear train during rotation thereof in the second direction, mapping rotational synchronization of the gear train rotating in the second direction, creating a second gear synchronization map of the gear train rotating in the second direction, and comparing the first gear synchronization map with the second gear synchronization map to determine backlash of the gear train.

In yet another alternative embodiment, a method of analyzing backlash of a gear train comprises rotating a gear train in a first direction, controlling torque load of the gear train during rotation in the first direction, mapping rotational synchronization of the gear train rotating in the first direction, rotating the gear train in a second direction opposite the first direction, controlling torque load of the gear train during rotation in the second direction, mapping rotational synchronization of the gear train rotating in the second direction, overlaying the first gear synchronization map with the second gear synchronization map, comparing the overlaid first gear synchronization map with the overlaid second gear synchronization map to determine backlash of the gear train.

### BRIEF DESCRIPTION OF THE DRAWINGS

Objects and advantages together with the operation of the invention may be better understood by reference to the following detailed description taken in connection with the following illustrations, wherein:

FIG. 1 is a diagrammatical representation of a pair of spur gears in mating engagement with each other;

FIG. 2 is a graphical representation of a blank mapping of a gear synchronization;

FIG. 3 is a graphical representation of a mapping of a gear synchronization of the meshing gears rotated in a clockwise direction;

FIG. 4 is a graphical representation of a mapping of a gear synchronization of the meshing gears rotated in a counter-clockwise rotation;

FIG. 5 is a graphical representation of the mapping of FIGS. 3 and 4 overlaid upon each other to determine certain characteristics of the meshing gears; and

FIG. 6 is a diagrammatical representation of an apparatus used to evaluate automotive differential carrier assemblies.

### DETAILED DESCRIPTION OF THE INVENTION

While the present invention is described with reference to the embodiments described herein, it should be clear that the present invention should not be limited to such embodiments. Therefore, the description of the embodiments herein is illustrative of the present invention and should not limit the scope of the invention as claimed.

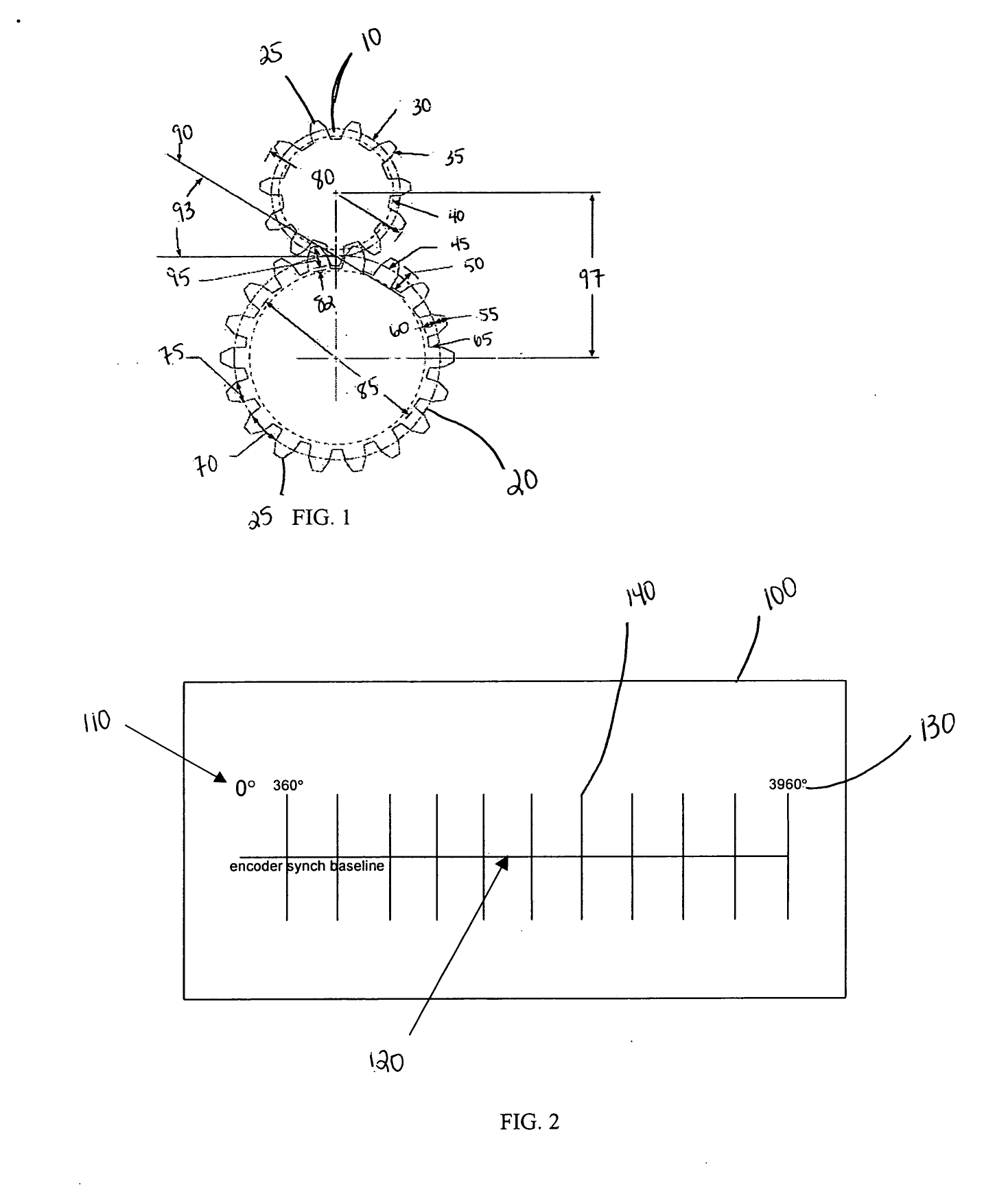

The present invention is a method and apparatus to dynamically analyze a gear train to determine the backlash present in the gears of a gear train. While the present embodiment is designed for use with transmission differential carrier assemblies, the invention can be used to analyze any gearing operation. For example, the present invention can be used with the following types of gears: spur, which is shown in FIG. 1, rack, bevel, planetary, worm, and helical. As shown in FIG. 1 a first spur gear 10 is in mating engagement with a second spur gear 20. Each of the gears 10, 20 have a plurality of teeth 25. Each of the gears 10, 20 also have a pitch circle 30 (shown on gear 10), a tooth profile 35, a base circle 40, a pitch circle 45 (shown on gear 20), a whole depth 50, an addendum 55, a dedendum 60, a root fillet 65, a circular pitch 70, a circular tooth thickness 75, an outside diameter 80, a clearance 82, and a root diameter 85. Further, the engagement of the gears 10, 20 also has several characteristics. As shown in FIG. 1, these characteristics include a line of action 90, a pressure angle 93, a working depth 95, and a center distance 97.

The present method could be used to pretest preselected gears or to test selected gears already fit into their respective assemblies. The analysis can provide measurement of backlash between a driven gear and output gear continuously from a starting contact point throughout the entire scope of contact until the gear train is cycled, via its ratio, back to its starting point. Other symptomatic analysis, using test data, can be used to diagnose other gear train problems.

The present method uses servo encoder technology to map the rotational synchronization between two mating gears 10, 20 rotating as the gears rotate in a clockwise direction and then in a counter-clockwise direction. Although it should be understood that the order of the directions can be changed so that the gears are rotated in the counter-clockwise direction and then in the clockwise direction. As the gears 10, 20 rotate, a consistently controlled torque load is applied. The consistently controlled torque load allows for more accurate determinations. Otherwise, if too much or too little torque load is applied, errant readings are possible. In particular, if too much torque is applied and the gears are made of a softer material, the gears may be considered to have too much backlash, when in fact there is not that much backlash present. Alternatively, if the gears are made of a harder material and too little torque load is applied, the results may provide that there is little to no backlash, when in fact there is backlash present. Therefore, a consistently applied torque load results in more accurate results. This torque load should resemble the operating torque load applied to the gears during normal operation thereof to determine the actual backlash present during normal operation of the gears.

The resultant maps of synchronization are then compared/analyzed to find significant characteristics relating to the pairing of two or more gears. An example of how the information may be displayed or mapped is shown in FIG. 2. FIG. 2 shows a blank gear synchronization map 100. The map 100 includes an encoder rotational count 110, an encoder synchronization baseline 120, and an end encoder rotational count 130. If there were no imperfections and/or backlash allowed in the gears 10, 20 the gear synchronization map 100 would depict what the true synchronization of the driver and output gears would be, e.g., a straight line along the encoder synchronization baseline 120.

The gear synchronization map 100 also feature crossbars 140 representing each 360° of rotation of the driven gear. In this example map 3960°, or 11 rotations of the driven gear is required to return the gear train to its starting contact point. However, any number of rotations can be used. The proper number will depend on the gear sizes and speed of rotation.

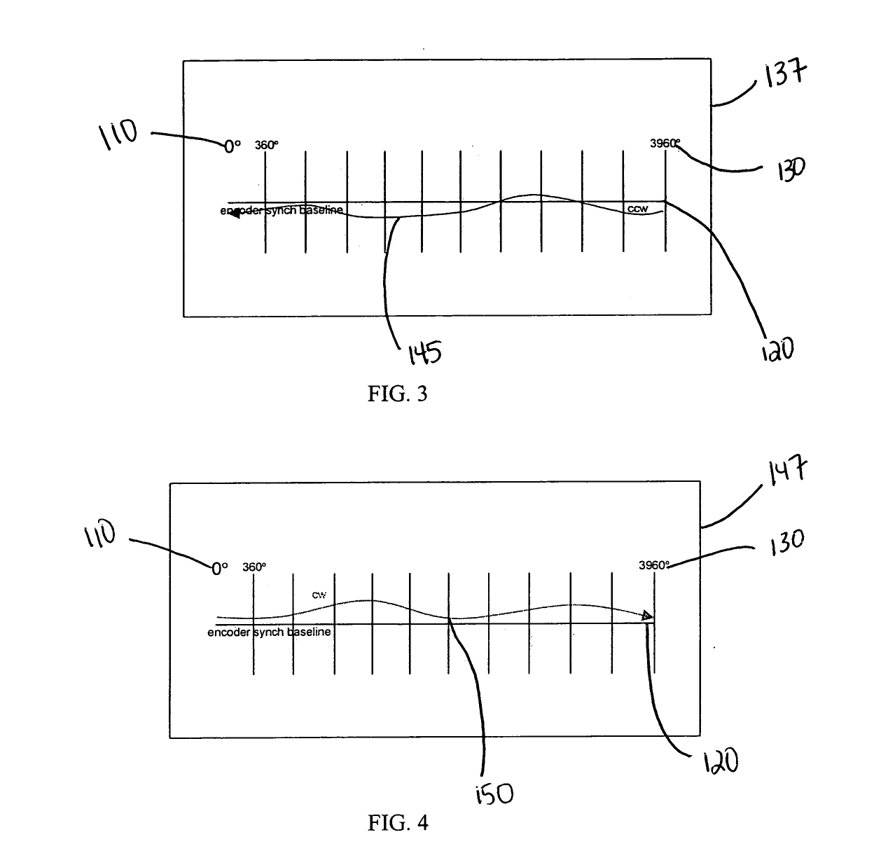

FIG. 3 depicts the mapping of the counter-clockwise rotation of the driver gear 137. The curve 145 may move toward and away from the encoder synchronization baseline 120, sometimes crossing over the encoder synchronization baseline 120 as the gear train is driven through its full range of contact points.

After the counter-clockwise rotation is mapped the clockwise rotation is mapped using the same resistance torque. This mapping 147 is shown in FIG. 4. In FIG. 4, the curve 150 may move toward and away from the encoder synchronization baseline 120, sometimes crossing over the encoder synchronization baseline 120 as the gear train is driven through its full range of contact points.

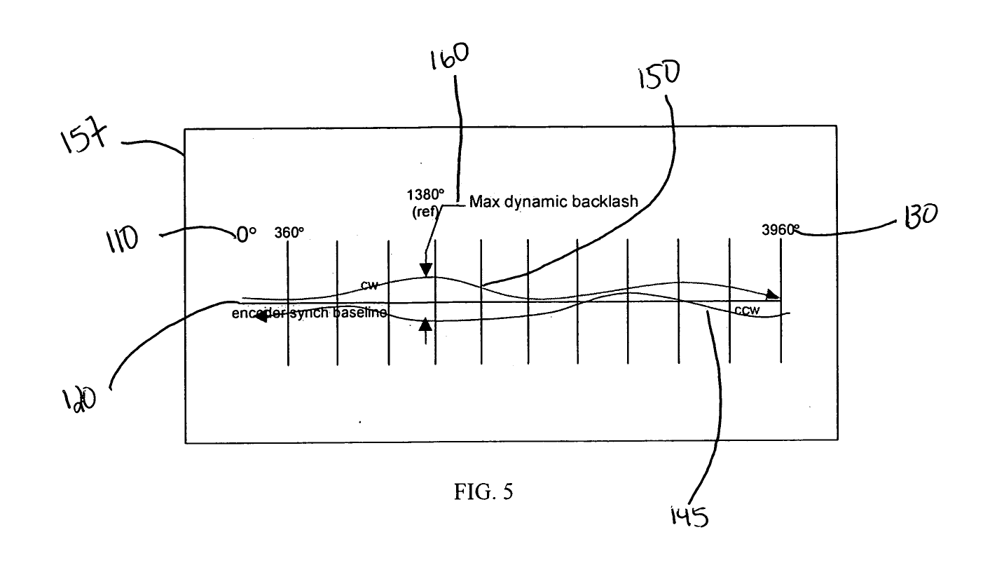

The two maps 137, 147 are then overlaid one on top of the other, as shown in FIG. 5 creating a third gear synchronization map 157. This can be done manually, or by a computer and computer program. When the two maps 137, 147 are overlaid onto the baseline 120, patterns begin to emerge indicating different characteristics of the gear train, see FIG. 5. More specifically, the two curves 145, 150 are compared to identify patterns that indicate certain characteristics of the gear train, such as backlash. In FIG. 5, given all the measured points captured, the maximum backlash can be captured and the rotational cycle of the gear train where the maximum backlash occurred can be identified. As shown in FIG. 5, the maximum backlash is identified as 160 and the rotational cycle of the gear train where the maximum backlash 160 occurred is at 1380°.

The data captured may be analyzed to discover other information relevant to the characteristics of the gear train including, but not limited to, specific gear (tooth form) defects, assembly problems, and other clearance issues not relating to tooth form.

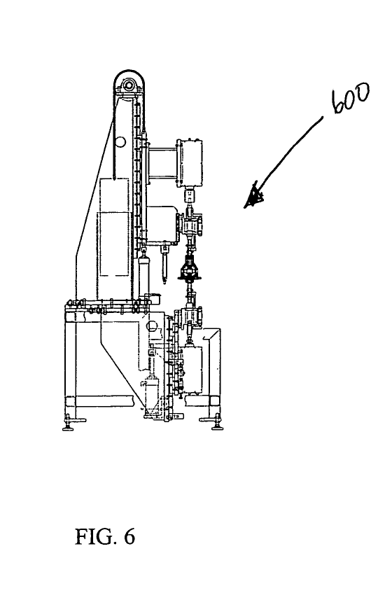

Shown in FIG. 6, is an example of an apparatus 600 used to evaluate automotive differential carrier assemblies. FIG. 6 shows the equipment layout to perform the analysis in a production environment. Key features of the apparatus are a part holding/locating device, gear interface/coupling devices, drive mechanism configured with servo motor/s and encoder/s used to drive the gear train, reaction device used to capture output gear positional information while applying a consistent torque load during analysis, and a control system capable of capturing the data and analyzing it. The primary purpose of the apparatus of FIG. 6 is to evaluate each differential case assembly's gear set backlash. It is merely an exemplary embodiment and any configuration can be used to accomplish such.

Although the preferred embodiment of the present invention has been illustrated in the accompanying drawings and described in the foregoing detailed description, it is to be understood that the present invention is not to be limited to just the preferred embodiment disclosed, but that the invention described herein is capable of numerous rearrangements, modifications and substitutions without departing from the scope of the claims hereafter.

Having thus described the invention, we claim:

1. A method of analyzing characteristics of a gear train, said method comprising:
rotating a gear train in a first direction;
creating a first gear synchronization map of said gear train rotating in said first direction;
rotating said gear train in a second direction opposite said first direction;
creating a second gear synchronization map of said gear train rotating in said second direction; and
controlling torque load of said gear train during rotation thereof in said first and second directions;
comparing said first gear synchronization map with said second gear synchronization map to determine relevant characteristics of said gear train.

2. The method of claim 1, further comprising comparing said first gear synchronization map with said second gear synchronization map to determine backlash of said gear train.

3. The method of claim 2, further comprising determining maximum backlash of said gear train.

4. The method of claim 3, further comprising determining rotational cycle of said gear train where said maximum backlash occurred.

5. The method of claim 4, further comprising overlaying said first gear synchronization map with said second gear synchronization map to compare said first gear synchronization map with said second gear synchronization map to determine maximum backlash and to determine rotational cycle of said gear train where maximum backlash occurred.

6. The method of claim 1, further comprising determining at least one of said characteristics of said gear train: gear defects, assembly problems, clearance issues not relating to tooth form.

7. The method of claim 1, wherein said gear train comprises at least a first gear and a second gear in meshing engagement.

8. The method of claim 1, wherein said first direction is clockwise and said second direction is counter-clockwise.

9. The method of claim 1, wherein said first direction is counter-clockwise and said second direction is clockwise.

10. A method of analyzing backlash of a gear train, said method comprising:
rotating a gear train in a first direction;
controlling torque load of said gear train during rotation thereof in said first direction;
mapping rotational synchronization of said gear train rotating in said first direction;
creating a first gear synchronization map of said gear train rotating in said first direction;
rotating said gear train in a second direction opposite said first direction;
controlling torque load of said gear train during rotation thereof in said second direction;
mapping rotational synchronization of said gear train rotating in said second direction;
creating a second gear synchronization map of said gear train rotating in said second direction; and
comparing said first gear synchronization map with said second gear synchronization map to determine backlash of said gear train.

11. The method of claim 10, wherein comparing said first gear synchronization map with said second gear synchronization map comprises overlaying said first gear synchronization map with said second gear synchronization map to determine backlash of said gear train.

12. The method of claim 11, further comprising determining maximum backlash of said gear train.

13. The method of claim 12, further comprising determining rotational cycle of said first and said second gears where said maximum backlash occurred.

14. The method of claim 11, wherein said gear train comprises at least a first gear and a second gear in meshing engagement.

15. The method of claim 11, wherein said first direction is clockwise and said second direction is counter-clockwise.

16. The method of claim 11, wherein said first direction is counter-clockwise and said second direction is clockwise.

17. A method of analyzing backlash of a gear train, said method comprising:
rotating a gear train in a first direction;
controlling torque load of said gear train during rotation in said first direction;
mapping rotational synchronization of said gear train rotating in said first direction;
rotating said gear train in a second direction opposite said first direction;
controlling torque load of said gear train during rotation in said second direction;
mapping rotational synchronization of said gear train rotating in said second direction;
overlaying said first gear synchronization map with said second gear synchronization map; and
comparing said overlaid first gear synchronization map with said overlaid second gear synchronization map to determine backlash of said gear train.

18. The method of claim 17, wherein said gear train comprises a plurality of gears in meshing engagement with each other.

19. The method of claim 18, further comprising determining maximum backlash of said plurality of gears by comparing said overlaid first gear synchronization map with said overlaid second gear synchronization map.

20. The method of claim 19, further comprising determining rotational cycle of said maximum backlash by comparing said overlaid first gear synchronization map with said overlaid second gear synchronization map.
